(19) United States
(12) Patent Application Publication
(10) Pub. No.: US 2013/0064178 A1
(43) Pub. Date: Mar. 14, 2013

(54) System For Monitoring Electrical Power Distribution Lines In A Power Grid Using A Wireless Sensor Network

(71) Applicants: Adishesha CS, Bangalore (IN); Arun Vijayakumari Mahasenan, Trivandrum (IN)

(72) Inventors: Adishesha CS, Bangalore (IN); Arun Vijayakumari Mahasenan, Trivandrum (IN)

(21) Appl. No.: 13/231,236

(22) Filed: Sep. 13, 2011

(51) Int. Cl. H04W 4/00; G08C 19/16

(52) U.S. Cl. 370/328; 340/870.25

(57) ABSTRACT

A system is disclosed for monitoring electrical power distribution lines comprising a plurality of mesh networks. Each mesh network monitors electrical power distribution lines at a select location of the power grid. Each mesh network comprises a plurality of wireless sensors adapted for wireless communications therebetween. Each wireless sensor measures attributes of line voltage for an associated electrical power distribution line at the select location. A master sensor collects data from the other sensors in the mesh network and determining voltage in phase attribute data of the electrical power distribution lines at the select location. The master sensor comprises a gateway device for communication outside of the mesh network. A monitor device for communication with master sensors receives voltage and phase attribute data from the master sensors for monitoring operation of the electrical power distribution line power grid.

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD

The disclosure relates to a system for monitoring an electrical power distribution system using a wireless sensor network.

### BACKGROUND

Electrical power distribution systems often include overhead electrical power distribution lines mounted upon poles by a wide variety of mounting structure. Other distribution systems include underground distribution lines in which protected cables run under the ground surface. High voltage phasing meters are designed for use as safety tools by maintenance line workers to verify the status voltage and phase of the grid lines, phase angle between the lines and also phase sequencing. Even though feeder circuits in utility lines are intended to be well balanced in the initial deployment, one of the phases may turn out to be more heavily loaded than others. This leads to load imbalances.

Known high voltage phasing meters comprise high resistance reference and meter probes connected in series with a calibrated panel meter to read the voltage across the phase-to-phase or phase-to-ground terminals. They are designed for use as safety tools by high voltage line maintenance workers to verify the status of the line or equipment as nominal, induced or de-energized. Known devices for providing such measurements include contact type and non-contact type. With contact type a reference probe or transmitter and a meter probe or receiver are connected in series with a cable as the loop is closed with load terminals. With the non-contact type each probe has a meter and the probes close the circuit through wireless means.

The smart grid is a modern electric power grid infrastructure for improved efficiency, reliability and safety. The smart grid utilizes smooth integration of renewable and alternative energy sources through automated control and modern communication technologies. In the smart grid, reliable and on-line information becomes an important factor for reliable delivery of power from the generation units to the end users. The impact of equipment failures, capacity of limitations, and natural accidents and catastrophes, which cause power disturbances and outages, can be largely avoided by on-line power system condition monitoring, diagnostics and protection. There is a need for continuous, uninterrupted, real time monitoring of grid parameters as part of a smart grid system.

Presently, smart meter reading solutions are available to monitor home meters, end user facilities and the like with respect to energy consumption. Monitoring of load conditions and grid performance is available at a substation level. Otherwise, there are various high voltage phasing meters and the like, as mentioned above, used for mainly diagnosing the distribution and utility grids. These are designed for use of safety tools to verify the status voltage and phase of the grid lines, phase angle between the lines and hence phase sequencing. A variety of phasing meters are used in a manual mode for diagnosis. However, none of these options provide continuous monitoring and intercommunication.

### SUMMARY

A sensor network diagnoses and monitors electrical power distribution lines in a power grid.

There is disclosed herein a system for monitoring electrical power distribution lines comprising a plurality of mesh networks. Each mesh network monitors electrical power distribution lines at a select location of the power grid. Each mesh network comprises a plurality of wireless sensors adapted for wireless communications therebetween. Each wireless sensor measures attributes of line voltage for an associated electrical power distribution line at the select location. A master sensor collects data from the other sensors in the mesh network and determines voltage and phase attribute data of the electrical power distribution lines at the select location. The master sensor comprises a gateway device for communication outside of the mesh network. A monitor device for communication with master sensors receives voltage and phase attribute data from the master sensors for monitoring operation of the electrical power distribution line power grid.

It is a feature that the monitor device comprises a handheld device.

It is another feature that the monitor device comprises a personal computer.

It is another feature that the master sensor synchronizes timing of the wireless sensors in each mesh network. The master sensor may synchronize timing responsive to receiving GPS data.

It is still another feature that the wireless sensors in each mesh network communicate with each other using Wi-Fi communications.

It is a further feature that the wireless sensors in each mesh network communicate with each other using Zigbee communications.

It is yet another feature that each wireless sensor is affixed to the associated electrical power distribution line.

It is still another feature that each master sensor determines phase angle measurement and phase sequencing for the master sensor's associated mesh network.

It is yet another feature that the gateway device is adapted to communicate with the monitor device using internet protocol.

There is further disclosed a sensor network for diagnosing and monitoring electrical power distribution lines in a power grid comprising a plurality of mesh networks each for monitoring electrical power distribution lines at a select location of the power grid. Each mesh network comprises a plurality of wireless sensors adapted for wireless communications therebetween. Each wireless sensor measures attributes of line voltage for an associated electrical power distribution line at the select location. One of the wireless sensors comprises a master sensor. The master sensor is adapted to collect line voltage data from the other sensors in a mesh network and environmental data at the select location that is adapted to determine voltage and phase attributes and prepare sample data of electrical power distribution lines at the select location. The master sensor comprises a gateway communication device for transmitting the samples of data outside of the mesh network. A monitor device in communication with master sensors receives sample data from the master sensors for diagnosing and monitoring operation of the electrical power distribution line power grid.

Other features and advantages will be apparent from a review of the entire specification, including the appended claims and drawings.

### BRIEF DESCRIPTION OF THE DRAWINGS

FIG. 1 is a generalized view of a mesh network in a system for monitoring electrical power distribution lines in a power grid;

FIG. 2 is a block diagram illustrating a mesh network using a handheld device;

FIG. 3 is a high level architecture representation of a sensor network;

FIG. 4 is a timing diagram illustrating measurement and data collection of monitored parameters;

FIG. 5 is a block diagram of a sensor mesh network using Wi-Fi communication; and

FIG. 6 is a block diagram of a sensor mesh network using Zigbee based communication.

### DETAILED DESCRIPTION

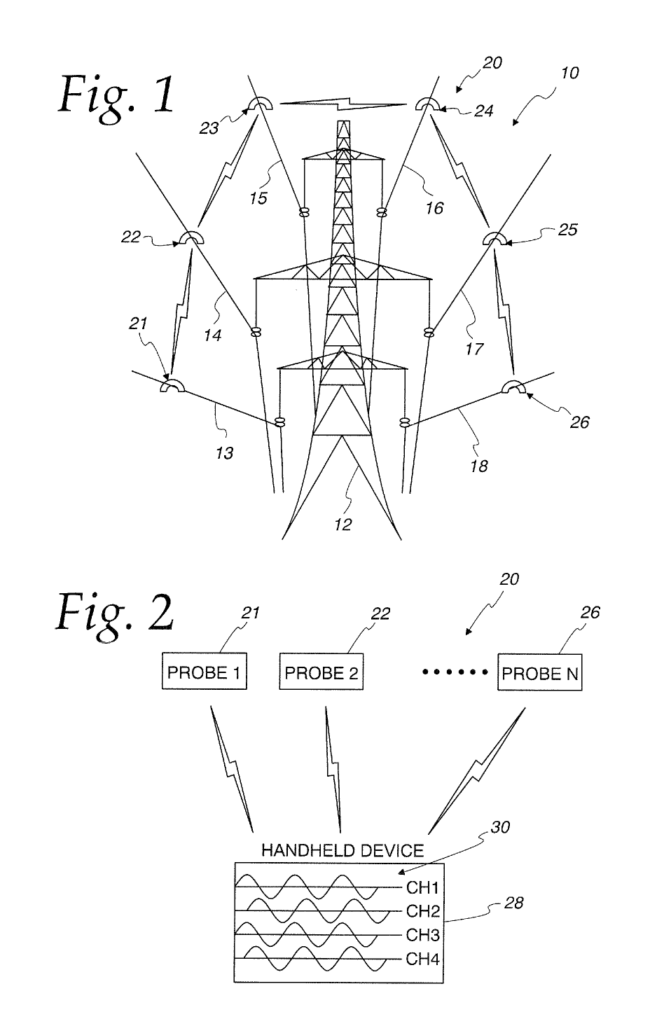

Described herein is a system for monitoring electrical power distribution lines uses sensor networking with phase ID meters permanently affixed to the distribution and utility grids and equipment. Referring initially to FIG. 1, a portion of a power grid 10 at a select location comprises a tower 12 carrying a plurality of electrical power distribution lines 13, 14, 15, 16, 17 and 18. Each line 13-18 carries high voltage power of alternating current. The power carried on each line of the first three conductors 13-15 are 120 degrees out of phase with the others, as is conventional. Likewise, the power on the other lines 16-18 are 120 degrees out of phase with each other.

A wireless mesh network 20 is provided in association with power grid 10 for monitoring electrical power distribution lines 13-18 at the location of the tower 12. The mesh network 20 comprises a plurality of wireless sensors 21, 22, 23, 24, and 26, also referred to herein as probes or wireless probes. Each probe 21-26 is affixed to and measures attributes of line voltage for an associated electrical power distribution line 13-18, respectively. For example, the first probe 21 measures attributes of power on the first line 13. The probes 21-26 are adapted for wireless communications therebetween. As described more particularly below, the first probe 21 comprises a master probe for collecting data from the other probes 22-26 in the mesh network 20 and determines voltage and phase attribute data of the electrical power distribution lines at the select location. The phase attribute data may include phase of the grid lines, phase angle between the lines, phase sequencing, and the like. As is apparent, any of the probes 21-26 could function as the master probe.

Each probe 21-26 comprises a phase ID meter and supports sensing for monitoring voltage, fault current, phasing attributes and physical parameters of the grid, such as temperature, humidity and ambient pressure and frequency of the high voltage signal. How the sensing is performed does not form part of the invention and thus is not discussed in detail herein. Each probe 21-26 could obtain power from its associated high voltage line 13-18, respectively. For measurement purposes, the probes 21-26 must synchronize their clocks. The master probe 21 may act as a master clock and provide synchronized time to the other probes 22-26. Also, the synchronized time could be provided from GPS time. The time synchronization among the probes 21-26 is used for phase attribute measurements as described below. Each probe 21-26 is configured with Wi-Fi or Zigbee communication to communicate therebetween in the mesh network 20. External long haul communication is performed using systems such as GSM/GPRS, etc.

As shown in FIG. 2, the probes 21-26 in the mesh network 20 could be monitored in the field on a handheld device 28. The handheld device 30 may be a PDA, smart phone or the like, configured to use Wi-Fi or Zigbee communications to communicate with each of the probes 21-26. The handheld device 30 can receive the data from each of the probes 21-26 and determine phasing, phase sequencing and the like for display as at 30 for local monitoring and diagnosis.

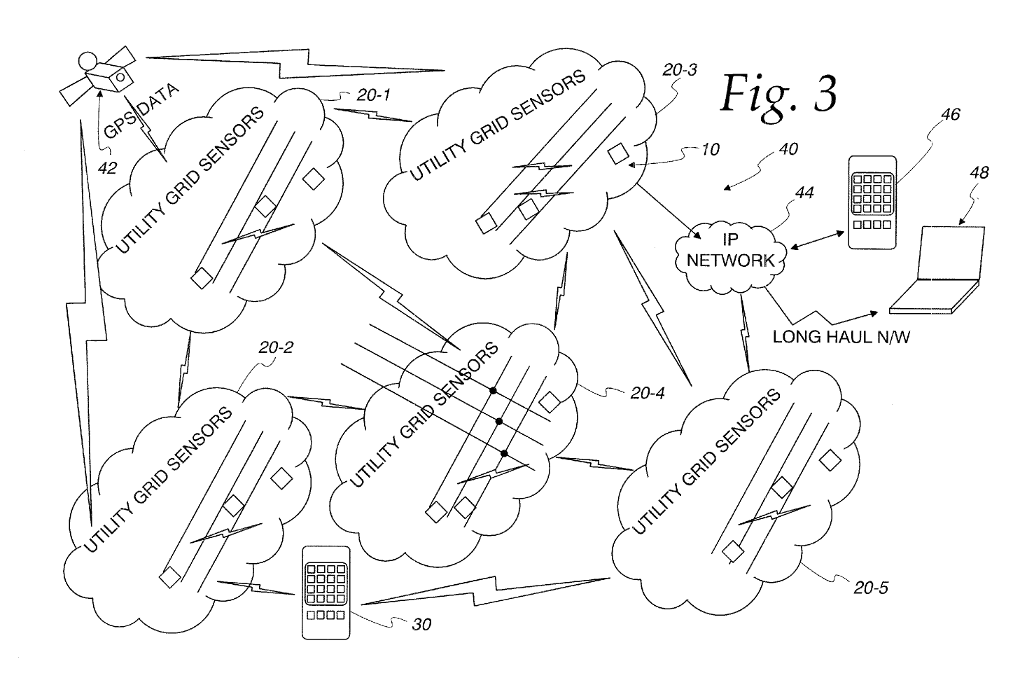

Referring to FIG. 3, a high level architecture diagram illustrates an overall system 40 for diagnosing and monitoring electrical power distribution lines in the power grid 10. The system 40 includes a plurality of mesh networks 20-1, 20-2, 20-3, 20-4 and 20-5. Each of the individual mesh networks is generally similar to the mesh network 20 shown in FIG. 1, and thus for simplicity herein is described generically with the numeral 20. As is apparent, each mesh network 20 can have a different number of wireless probes depending on the number of power lines and the like. As is shown, the various mesh networks 20 can communicate with one another. Likewise, GPS data can be downloaded from a GPS satellite 42 as shown to the mesh networks 20-1, 20-2 and 20-3. Moreover, the mesh networks 20 can communicate directly with the local handheld device 30, as shown with respect to the mesh networks 20-2 and 20-5. The mesh networks 20 can communicate using Internet protocol over an IP network 44 such as shown with the mesh networks 20-3 and 20-5 to in turn communicate with a remote handheld device 46 or a server 48. The remote handheld device 46 can be a PDA, smart phone, or proprietary device. Likewise, the server 48 can be a laptop computer, a personal computer or any type of server such as might be located at a substation or centralized location.

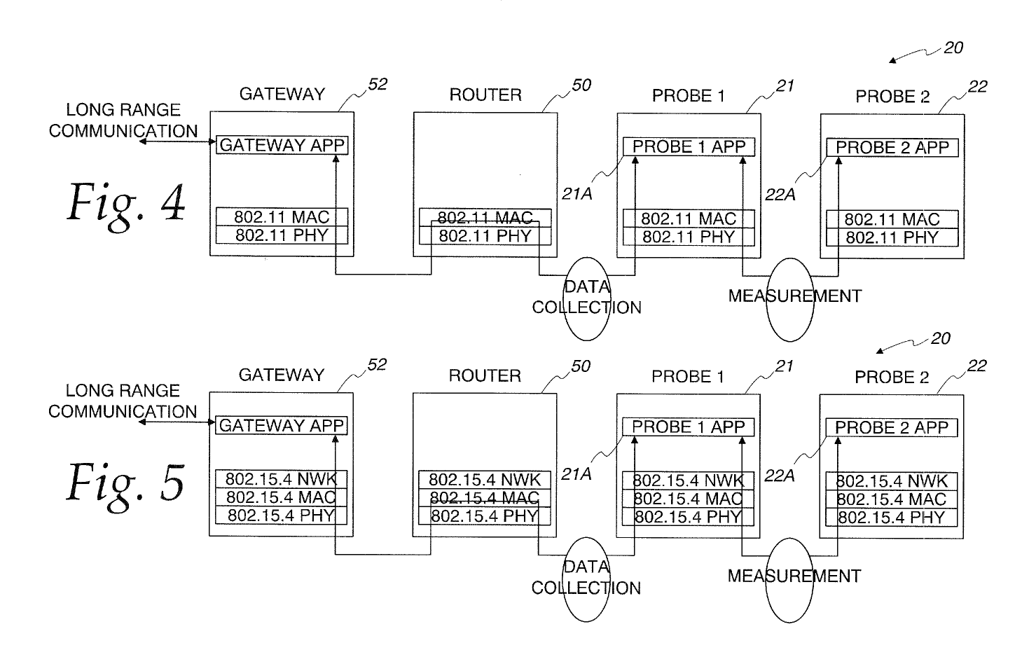

Referring to FIG. 4, block diagram illustrates an implementation for the mesh network 20 using Wi-Fi communications. In this diagram, the system is shown with the first probe 21 and the second probe 22. The other probes 23-26 are not shown in this diagram. The mesh network 20 also includes a router 50 and a gateway 52. Each of the probes 21, 22 and the router 50 and the gateway 52 can be configured as a processing device including a processor and associated memory and the like necessary to achieve its necessary operation. Software is illustrated by application layers shown. The first probe 21 includes a PROBE 1 app 21A, while the second probe 22 includes a PROBE 2 app 22A. Each of these apps 21A and 22A is used for performing measurement functions on the associated power line, such as the lines 13 and 14, see FIG. 1. The apps 21A and 22A are enabled to measure fault current indication, voltage detection, voltage measurement for utilities, phasing, phase angle measurement, phase sequencing, temperature, pressure, humidity as well as signal processing, data aggregation and communication, in any known manner. Communication is enabled using an 802.11 MAC media access control layer and an 802.11 PHY physical layer. As is apparent, communication is necessary between multiple probes for voltage measurement, phasing, phase angle and phase sequencing. The probes 21 and 22 use the wireless network for exchanging sample data for measurement and sending measured data to the gateway 52 via the router 50. For example, measurement data is transferred wirelessly from the second probe 22 (or any of the other probes 23-26) to the first probe 21. The data is collected and transferring to a gateway app 52A of the gateway 52. The collected data can be processed in the gateway 52 or transferred to other devices in the system 40.

The algorithms of the router 50 and the gateway 52 can be included in the first probe 21 to render it a master probe

FIG. 5 is a diagram similar to FIG. 4 except communications is by Zigbee communication using 802.15.14 protocol utilizing the network, media access control and physical layers as illustrated.

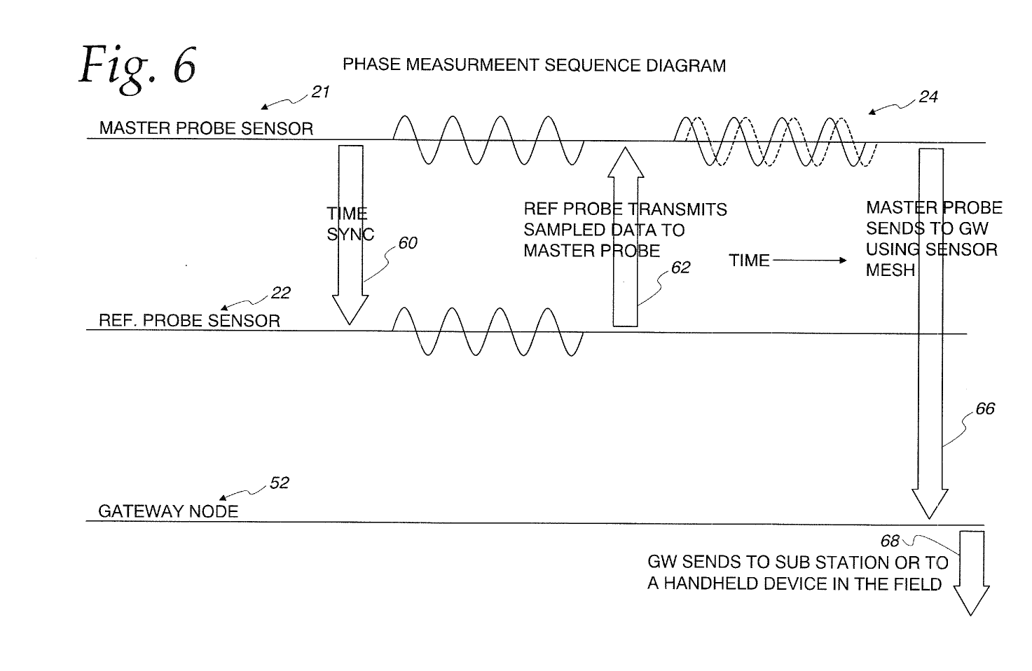

Referring to FIG. 6, a phase measurement sequence diagram illustrates interoperation within a mesh network 20. As mentioned above, time synchronization can be obtained using the clock from the master probe 21. This could be an internal clock or synchronized with GPS time. The master probe 21 provides clock signals and performs measurements initiated by sending a time signal as represented by an arrow 60 to the second probe 22. The second probe 22 synchronizes with the master probe 21 and sends sample data to the master probe as indicated at 62. The master probe 21 then correlates the sample data with its own data as at 64 and sends the combined data to the gateway node 52 as indicated at 66. The gateway node 52 acts as the gateway for the sensor mesh 20 and has long range communication with the server 48 or handheld device 46 using long range communications such as IP protocol as indicated at 68.

As described, the system 40 provides 8 solution for monitoring the overall health of the power grid 10 using individual mesh networks 20. This grid level monitoring facilitates speedy and efficient troubleshooting by maintenance workers who have access to details of every grid between utility distribution points. The use of GPS also enables a prior survey for location of probes and thus localizes points of fault and assists in troubleshooting. This system 40 facilitates knowing the grid status at the substation and at other remote locations of interest and provides real time alerts to improve efficiency and quality of grid maintenance.

The wireless sensor networks provide a feasible and cost effective sensing and communication solution for remote system monitoring and diagnosis. The efficient monitoring system constructed of large scale deployment of smart sensor nodes can provide complete information on system components, including generation units, transformers, transmission lines, motors, etc. in a remote and online manner. With the online system monitoring and system level coordinating controls and protections, a single system contingency in the power grid or facility could be detected and isolated before it causes cascading effects and results in more catastrophic system breakdowns.

The gateway node device 52 may be provided with storage capability for storing the sample data for the particular mesh network 20. All of the parameters measured by the probes 21-26 in the mesh network 20 are continuously monitored by built-in control logic in the gateway 52. In case any parmeter heing monitored exceeds an operational limit, an alert message can be generated by the gateway 52 and transmitted to the server 48 or the like for decision making. The decision could prompt an operational crew to speed up maintenance activity while ahead of any possible failure or power outage or hazard. Historical data stored in the gateway 52 could be used for trend analysis, estimation of power losses or outages and pre-scheduling maintenance activities and component replacements. Alternatively, all computations and decision making could happen in the gateway and the critical information could be transmitted to the sub-station or server to reduce load and cost on the long haul network.

It will be appreciated by those skilled in the art that there are many possible modifications to be made to the specific forms of the features and components of the disclosed embodiments while keeping within the spirit of the concepts disclosed herein. Accordingly, no limitations to the specific forms of the embodiments disclosed herein should be read into the claims unless expressly recited in the claims. Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

The present invention has been described with respect to block diagrams. It will be understood that each block of the block diagrams can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer implemented process such that the instructions which execute on the processor provide steps for implementing the functions specified in the blocks. Accordingly, the illustrations support combinations of means for performing a specified function and combinations of steps for performing the specified functions. It will also be understood that each block and combination of blocks can be implemented by special purpose hardware-based systems which perform the specified functions or steps, or combinations of special purpose hardware and computer instructions.

1. A system for monitoring electrical power distribution lines in a power grid comprising:
a plurality of mesh networks each monitoring electrical power distribution lines at a select location of the power grid, each mesh network comprising a plurality of wireless sensors adapted for wireless communications therebetween, each wireless sensor measuring attributes of line voltage for an associated electrical power distribution line at the select location, a master sensor for collecting data from the other sensors in the mesh network and determining voltage and phase attribute data of the electrical power distribution lines at the select location, the master sensor comprising a gateway device for communication outside of the mesh network; and
a monitor device for communication with the master sensors for receiving voltage and phase attribute data from the master sensors for monitoring operation of the electrical power distribution line power grid.

2. The system for monitoring electrical power distribution lines in a power grid of claim 1 wherein the monitor device comprises a handheld device.

3. The system for monitoring electrical power distribution lines in a power grid of claim 1 wherein the monitor device comprises a personal computer.

4. The system for monitoring electrical power distribution lines in a power grid of claim 1 wherein the master sensor synchronizes timing of the wireless sensors in each mesh network.

5. The system for monitoring electrical power distribution lines in a power grid of claim 4 wherein the master sensor synchronizes timing responsive to receiving GPS data.

6. The system for monitoring electrical power distribution lines in a power grid of claim 1 wherein the wireless sensors in each mesh network communicate with each other using Wi-Fi communications.

7. The system for monitoring electrical power distribution lines in a power grid of claim 1 wherein the wireless sensors in each mesh network communicate with each other using Zigbee communications.

8. The system for monitoring electrical power distribution lines in a power grid of claim 1 wherein each wireless sensor is affixed to the associated electrical power distribution line.

9. The system for monitoring electrical power distribution lines in a power grid of claim 1 wherein each master sensor determines phase angle measurement and phase sequencing for the master sensors associated mesh network.

10. The system for monitoring electrical power distribution lines in a power grid of claim 1 wherein the gateway device is adapted to communicate with the monitor device using Internet protocol.

11. A sensor network for diagnosing and monitoring electrical power distribution lines in a power grid comprising:
a plurality of wireless mesh networks each for monitoring electrical power distribution lines at a select location of the power grid, wherein each mesh network comprising a plurality of wireless sensors adapted for wireless communications therebetween, each wireless sensor measuring attributes of line voltage for an associated electrical power distribution line at the select location, one of the wireless sensors comprising a master sensor, the master sensor being adapted to collect line voltage data from the other sensors in the mesh network and environmental data at the select location and being adapted to determine voltage and phase attributes and prepare sample data of the electrical power distribution lines at the select location, the master sensor comprising a gateway communication device for transmitting the sample data outside of the mesh network; and
a monitor device in communication with the master sensors for receiving sample data from the master sensors for diagnosing and monitoring operation of the electrical power distribution line power grid.

12. The sensor network for diagnosing and monitoring electrical power distribution lines in a power grid of claim 11 wherein the monitor device comprises a handheld device.

13. The sensor network for diagnosing and monitoring electrical power distribution lines in a power grid of claim 11 wherein the monitor device comprises a personal computer.

14. The sensor network for diagnosing and monitoring electrical power distribution lines in a power grid of claim 11 wherein the master sensor synchronizes timing of the wireless sensors in each mesh network.

15. The sensor network for diagnosing and monitoring electrical power distribution lines in a power grid of claim 14 wherein the master sensor synchronizes timing responsive to receiving GPS data.

16. The sensor network for diagnosing and monitoring electrical power distribution lines in a power grid of claim 11 wherein the wireless sensors in each mesh network communicate with each other using Wi-Fi communications.

17. The sensor network for diagnosing and monitoring electrical power distribution lines in a power grid of claim 11 wherein the wireless sensors in each mesh network communicate with each other using Zigbee communications.

18. The sensor network for diagnosing and monitoring electrical power distribution lines in a power grid of claim 11 wherein each wireless sensor is affixed to the associated electrical power distribution line.

19. The sensor network for diagnosing and monitoring electrical power distribution lines in a power grid of claim 11 wherein each master sensor determines phase angle measurement and phase sequencing for the master sensors associated mesh network.

20. The sensor network for diagnosing and monitoring electrical power distribution lines in a power grid of claim 11 wherein the gateway device is adapted to communicate with the monitor device using internet protocol.
